(19) United States
(12) Patent Application Publication
(10) Pub. No.: US 2007/0126332 A1
(43) Pub. Date: Jun. 7, 2007

(54) Color picture tube

(75) Inventors: Takashi Murai, Hiratsuka-shi (JP); Tadahiro Kojima, Chigaskai-shi (JP); Takeshi Nakayama, Hiratsuka-shi (JP); Nobuyuki Seto, Ibaraki-shi (JP)

Correspondence Address: HAMRE, SCHUMANN, MUELLER & LARSON, P.C., P.O. BOX 2902, MINNEAPOLIS, MN, 55402-0902, US

(73) Assignee: Matsushita Toshiba Picture Display Co., Ltd., Takatsuki-shi (JP)

(21) Appl. No.: 11/598,452

(22) Filed: Nov. 13, 2006

(30) Foreign Application Priority Data
Dec. 2, 2005 (JP) 2005-349441
Apr. 19, 2006 (JP) 2006-115841

(51) Int. Cl. H01J 29/86

(52) U.S. Cl. 313/477 R

(57) ABSTRACT

The radii of curvature R_{D}, R_{S} and R_{L} along a diagonal axis, a short side and a long side of an outer surface of a useful portion of a panel whose inner surface is provided with a phosphor screen satisfy R_{D}≧10 m, R_{S}>R_{D}, and R_{L}>R_{D}. This makes it possible to provide a color picture tube that has an excellent visibility and is not susceptible to the deterioration in color purity due to doming, while including a shadow mask with excellent formability and strength.

### BACKGROUND OF THE INVENTION

1. Field of the Invention

The present invention relates to a color picture tube including a shadow mask.

2. Description of Related Art

In general, as shown in FIG. 7, a color picture tube has a glass envelope 9 including a substantially rectangular panel 1 in which a lateral wall portion 1b is provided on the periphery of a useful portion 1a having a curved surface, and a funnel 2 in a funnel shape joined to the lateral wall portion 1b. An inner surface of the useful portion 1a of the panel 1 is provided with a substantially rectangular phosphor screen 3 formed of black non-light-emitting material layers and phosphors of three colors, i.e., green, blue and red that are filled in gaps between these black non-light-emitting material layers. Each of the phosphors is formed in a stripe shape extending along a short side direction, and a large number of these phosphor stripes are arranged in a long side direction.

Further, a shadow mask structure 5 is provided so as to face this phosphor screen 3. The shadow mask structure 5 includes a shadow mask 4 having a large number of apertures for passing electron beams (electron beam passage apertures), and a mask frame 11 in a substantially rectangular frame shape for supporting the shadow mask 4.

As shown in FIG. 8, the shadow mask 4 includes a main surface portion 4a that is opposed to the useful portion 1a of the panel 1 and a skirt portion 4d that is connected to the main surface portion 4a in such a manner as to be bent substantially at a right angle to the main surface portion 4a. The main surface portion 4a includes a perforated region 4b that is provided with a large number of electron beam passage apertures 4e for selecting three electron beams 6B, 6G and 6R emitted from an electron gun 7 toward the three-color phosphors constituting the phosphor screen 3 and has a curved surface convex toward the phosphor screen 3, and a non-perforated region 4c that surrounds the perimeter of this perforated region 4b and is not provided with the electron beam passage apertures 4e.

The shadow mask 4 is supported by the mask frame 11 in a substantially rectangular frame shape such that its skirt portion 4d is attached to the mask frame 11. An elastic support (not shown) attached to the mask frame 11 is latched to a stud pin (not shown) provided on an inner wall surface of the lateral wall portion 1b of the panel 1, whereby the shadow mask structure 5 is attached to the panel 1 in such a manner as to be attachable and detachable.

Inside a neck 2a of the funnel 2, the electron gun 7 for emitting the three electron beams 6B, 6G and 6R is disposed. Also, an internal magnetic shield 10 attached to the mask frame 11 is arranged inside a large diameter portion of the funnel 2. A deflection device 8 is mounted on an outer peripheral surface of the funnel 2.

The three electron beams 6B, 6G and 6R emitted from the electron gun 7 are deflected by a magnetic field generated by the deflection device 8, pass through the electron beam passage apertures 4e of the shadow mask 4 and scan the phosphor screen 3 horizontally and vertically, whereby a color image is displayed.

Since an inner space of the envelope 9 is under vacuum, an external atmospheric pressure generates stress inside the envelope 9. Because of the aspherical shape of the envelope 9, this stress is not uniform, so that a tensile stress or a compressive stress with a certain distribution is generated. Thus, when some mechanical impact is applied to the envelope 9 so as to cause a local breakage or crack, the envelope 9 implodes easily. In order to prevent this implosion, an implosion-protection reinforcing band 12 for retaining the strength of the envelope 9 and preventing the implosion is wound around an outer peripheral surface of the lateral wall portion 1b of the panel 1.

In general, in order to display an image without color impurity on the phosphor screen 3 of the color picture tube, the three electron beams that have passed through the electron beam passage apertures 4e formed in the shadow mask 4 have to land on the three-color phosphors properly. For this purpose, it is necessary that the panel 1 and the shadow mask 4 should be maintained in a predetermined relationship, in particular, an interval (q value) between the phosphor screen 3 and the perforated region 4b of the shadow mask 4 facing the phosphor screen 3 should stay within a predetermined allowable range.

In the color picture tube including the shadow mask 4, on the principle of operation thereof, the electron beams that pass through the electron beam passage apertures of the shadow mask 4 and arrive at the phosphor screen 3 correspond to ⅓ or less of an overall amount of the electron beams emitted from the electron gun 7, and the remaining electron beams strike the shadow mask 4 and are transformed into thermal energy. Accordingly, the shadow mask 4 is heated, so that the resultant thermal expansion causes so-called doming in which the shadow mask 4 is deformed in such a manner as to bulge toward the phosphor screen 3. Due to this doming, when the interval (q value) between the phosphor screen 3 and the perforated region 4b of the shadow mask 4 exceeds the allowable range, the landing positions of the electron beams with respect to the phosphor screen 3 are displaced, thus deteriorating color purity.

In recent years, for the purpose of enhancing visibility, there is a demand that the radius of curvature of the outer surface of the useful portion 1a of the panel 1 is increased so as to bring the outer surface close to a flat surface. In this case, in terms of the strength of the envelope 9 with respect to the atmospheric pressure and the visibility, the radius of curvature of the inner surface of the useful portion 1a also has to be increased. In order to obtain appropriate beam landing when the radius of curvature of the inner surface of the useful portion 1a is increased, it also is necessary to increase the radius of curvature of the perforated region 4b of the shadow mask 4.

The increase in the radius of curvature of the perforated region 4b of the shadow mask 4 brings about a larger amount of doming. Therefore, the displacement amount of the landing positions of the electron beam also increases, thus deteriorating the color purity considerably. Accordingly, in the color picture tube having the panel 1 whose useful portion 1a has a substantially flat outer surface, in order to suppress doming, an alloy mainly containing iron and nickel having a low coefficient of thermal expansion is used generally as a material for the shadow mask 4. For example, an iron-nickel alloy such as a 36 Ni Invar alloy is used. Such an alloy has a coefficient of thermal expansion of 1 to 2×10⁻⁶ at 0° C. to 100° C., which is effective for suppressing doming; however, it entails high cost. Furthermore, the iron-nickel alloy has a large elasticity after annealing, so that it is difficult to form a curved surface by press forming from a thin metal sheet that has been provided with an extremely large number of the electron beam passage apertures and to obtain a desired curved surface. Even if the iron-nickel alloy is annealed at a temperature as high as 900° C., for example, the yield point strength is about 28×10⁷ N/m². Thus, it is necessary to treat the alloy at a considerably high temperature in order to set the yield point strength to be 20×10⁷ N/m² or less at which press forming generally is conducted easily. Therefore, it particularly is difficult to process the shadow mask 4 including the perforated region 4b with a large radius of curvature by press-forming this material.

In the case where press forming is insufficient and undesired stress remains in the shadow mask 4 after press forming, this residual stress changes the shape of the shadow mask 4 during the thermal process of the color picture tube, which leads to the displacement of the landing positions of the electron beams, resulting in significant deterioration in the color purity.

When the press forming of the shadow mask 4 is insufficient, the resultant shadow mask 4 has a lower mechanical strength (a curved surface retaining strength). Also, the mechanical strength of the press-formed shadow mask 4 decreases with an increase in the radius of curvature of the perforated region 4b.

The decrease in the mechanical strength of the shadow mask 4 causes the shadow mask 4 to be deformed easily by impacts and vibrations in the course of the production and operation of the color picture tube. As a result, the interval (q value) between the phosphor screen 3 and the perforated region 4b of the shadow mask 4 changes, so that the landing positions of the electron beams with respect to the phosphor screen 3 are displaced, thus deteriorating the color purity. Further, in the case where the color picture tube is incorporated into a TV set, the shadow mask 4 becomes more likely to resonate with the vibrations from a speaker, and this resonance changes the interval (q value) between the phosphor screen 3 and the perforated region 4b of the shadow mask 4, thus deteriorating the color purity.

On the other hand, with a material mainly containing high-purity iron, the yield point strength can be set to 20×10⁷ N/m² or less by annealing at about 800° C., so that press forming is very easy. Thus, it is not necessary to keep the press die temperature high at the time of press forming, which is required for an Invar alloy, and the productivity also is satisfactory.

However, the coefficient of thermal expansion of such a material mainly containing high-purity iron is as high as about 12×10⁻⁶ at 0° C. to 100° C., which is disadvantageous for doming. Particularly, in the case of applying this material to a color picture tube having the panel 1 whose useful portion 1a has the substantially flat outer surface, there arises a serious problem such as the considerable deterioration in color purity.

JP 2993437 B discloses a color picture tube including a panel with a substantially flat outer surface and a concavely curved inner surface. However, the radius of curvature of the inner surface is not sufficient to suppress effectively the above-described various problems regarding the shadow mask. Thus, there has been a significant problem especially in the case of using a shadow mask formed of an inexpensive iron material.

JP 3282553 B discloses a color picture tube including a panel whose outer surface has a radius of curvature of at least 6000 mm and less than 90000 mm. However, the radius of curvature of its inner surface is not small enough to suppress the above-described various problems effectively.

As described above, there has been a greatly increasing demand for a flattened outer surface of the useful portion 1a of the panel 1. On the other hand, the curved surface of the perforated region 4b of the shadow mask 4 is set to have a shape substantially according to the curved shape of the inner surface of the useful portion 1a of the panel 1. Therefore, with greater efforts to enhance the doming characteristics and the mechanical strength characteristics of the shadow mask 4, it becomes further necessary to focus on reducing the radius of curvature of the inner surface of the useful portion 1a of the panel 1. In other words, as shown in FIG. 9, the outer surface of the useful portion 1a of the panel 1 becomes flat, and the inner surface thereof becomes concavely curved with a predetermined radius of curvature. Consequently, the thickness of the useful portion 1a of the panel 1 becomes small in its central portion (thickness T₀) and large in its peripheral portion (thickness T₁), so that the difference in thickness between the central portion and the peripheral portion increases.

In general, nonuniformity of the stress that the atmospheric pressure generates in the envelope 9 by achieving a high vacuum in the inner space of the envelope 9 increases considerably when the outer surface of the useful portion 1a of the panel 1 is made flat. The maximum stress is generated in a border portion between the useful portion 1a and the lateral wall portion 1b of the panel 1. By reducing the radius of curvature of the inner surface of the useful portion 1a of the panel 1, this border portion becomes thicker. This is effective in alleviating the stress generated by the atmospheric pressure and advantageous in preventing the breakage and implosion of the envelope 9 caused by mechanical impacts.

However, the color picture tube is manufactured through several heat processes during its production process. In these heat processes, the envelope 9 is heated up to about 500° C. at maximum. For the mass production, the process time should be as short as possible, so that the envelope 9 is subjected to heating and cooling with a very large gradient of temperature variation. These rapid heating and rapid cooling steps make the temperature distribution inside the envelope 9 considerably nonuniform. In particular, a very large thermal stress is generated in the thick portion of the panel 1, causing a problem that the envelope 9 is broken.

Also, for the purpose of improving an image contrast, the use of low transmittance glass as the material for the panel 1 is mainstream. In this case, the transmittance of the panel 1 varies greatly in accordance with the thickness thereof. When the outer surface of the useful portion 1a of the panel 1 is made as flat as possible and the radius of curvature of the inner surface thereof is made small, the difference between the thickness T₀ of the central portion and the thickness T₁ of the peripheral portion of the useful portion 1a of the panel 1 increases, so that the difference in transmittance between the central portion and the peripheral portion of the useful portion 1a increases. As a result, there also has been a problem that the brightness of the image becomes nonuniform such that the central portion of a screen becomes bright and the peripheral portion thereof becomes dark.

Therefore, it is difficult to make the difference in thickness between the central portion and the peripheral portion of the useful portion 1a of the panel 1 larger than that in the conventional case, and there has been a limitation on the reduction of the radius of curvature of the inner surface of the panel 1 whose useful portion 1a has a flat outer surface. Accordingly, the radius of curvature of the perforated region 4b of the shadow mask 4 cannot be reduced sufficiently, either. Then, as described above, when the iron material that is inexpensive and has excellent formability is used as the material for the shadow mask 4, its large coefficient of thermal expansion causes a still larger displacement amount of the electron beam landing positions due to the thermal expansion of the shadow mask 4, thus deteriorating the color purity further.

In order to reduce the radius of curvature of the perforated region 4b of the shadow mask 4 without increasing the difference in thickness between the central portion and the peripheral portion of the useful portion 1a of the panel 1, it is necessary to reduce the radius of curvature of the inner surface of the useful portion 1a of the panel 1 and accordingly reduce the radius of curvature of the outer surface of the useful portion 1a. However, such a color picture tube is not compatible with the demand for a flatter outer surface of the useful portion 1a of the panel 1. Also, when such a color picture tube is mounted on a front cabinet of a TV set adapted for a conventional color picture tube whose useful portion 1a has a flat outer surface, which has been widespread so far (in the following, referred to as “the conventional flat tube”), a gap is formed between a peripheral portion of the outer surface of the useful portion 1a (namely, the vicinities of long sides and short sides) and a screen frame of the front cabinet. In other words, it is not possible to ensure compatibility of the front cabinet of the TV set with the conventional flat tube.

Further, the atmospheric pressure deforms the panel 1 such that the central portion of its useful portion 1a sags inward. The reinforcing band 12 is wound around and embraces tightly the lateral wall portion 1b of the panel 1, thereby deforming the useful portion 1a oppositely, in other words, such that its central portion bulges outward. In this manner, the stress generated in the envelope 9 by the atmospheric pressure is alleviated. However, when the outer surface of the useful portion 1a of the panel 1 is flattened, the effect of the reinforcing band 12 of deforming the useful portion 1a of the panel 1 such that its central portion bulges outward cannot be obtained easily, necessitating a reinforcing band generating a larger embracing force. As described above, when the outer surface of the useful portion 1a of the panel 1 is flattened, the peripheral portion of the useful portion 1a becomes thicker, which is advantageous in terms of the implosion-protection characteristics of the envelope 9; however, there is an upper limit on the thickness of the peripheral portion of the useful portion 1a in terms of the reduction of thermal stress and the uniformity of image brightness as described above. Therefore, flattening the outer surface of the useful portion 1a of the panel 1 has necessitated a reinforcing band generating a very large embracing force, thus preventing the cost reduction of the reinforcing band 12.

### SUMMARY OF THE INVENTION

With the foregoing conventional problems in mind, it is an object of the present invention to provide a color picture tube that includes an inexpensive shadow mask with excellent formability and strength, has an excellent visibility and a compatibility with a conventional flat tube concerning mounting on a TV set, and is not susceptible to the deterioration in color purity due to doming. Also, it is a further object of the present invention to provide a color picture tube that allows the use of a more inexpensive reinforcing band by eliminating the need for a considerable increase in an embracing force of the reinforcing band.

A color picture tube according to the present invention includes a panel having a substantially rectangular useful portion whose inner surface is provided with a phosphor screen, and a shadow mask having a perforated region as a curved surface provided with a large number of apertures for passing electron beams.

It is assumed that an axis that is perpendicular to a tangent plane to an outer surface of the useful portion at a center of the useful portion and passes through the center is a tube axis and that a point of intersection of a short side and a long side of the useful portion is a diagonal axis end.

R_{D}, defined by
R_{D}=[(S_{D}/2)²+Z_{D}²]/(2×Z_{D}) (1)
using a dimension S_{D} of the useful portion in a direction of the diagonal axis and a sagging amount Z_{D} along a direction of the tube axis at the diagonal axis end with respect to the center on the outer surface of the useful portion, indicates a radius of curvature along the diagonal axis of the outer surface of the useful portion.

R_{S} indicates a radius of curvature along the short side of the outer surface of the useful portion, and R_{L} indicates a radius of curvature along the long side of the outer surface of the useful portion.

The present invention satisfies
R_{D}≧10 m,
R_{S}>R_{D}, and
R_{L}>R_{D}.

### BRIEF DESCRIPTION OF THE DRAWINGS

FIG. 1 is a perspective view showing a schematic shape of a panel of a color picture tube according to an embodiment of the present invention.

FIG. 2 is a perspective view showing a shape of a first quadrant of an outer surface of a useful portion of the panel of the color picture tube according to an embodiment of the present invention.

FIG. 3 shows a variation of a ratio of a biquadratic component in a sagging amount Z_{V}x with respect to a distance from a center in a panel according to Example of the present invention.

FIG. 4 shows a display pattern at the time of measuring a beam movement amount due to doming.

FIG. 5 is a lateral view for describing a sagging back ratio provided by a reinforcing band.

FIGS. 6A and 6B show results of analyzing a reflected image on an outer surface of a useful portion of a panel in Example and Comparative Example, respectively.

FIG. 7 is a sectional view showing a schematic configuration of an exemplary color picture tube.

FIG. 8 is a perspective view showing a schematic configuration of an exemplary shadow mask.

FIG. 9 is a sectional view showing a panel whose useful portion has a flat outer surface.

### DETAILED DESCRIPTION OF THE INVENTION

In accordance with the present invention, by defining a shape of an outer surface of a useful portion of a panel in detail, the implosion-protection characteristics improve while ensuring visual flatness of this outer surface, making it possible to achieve a cost reduction of a reinforcing band. Also, since the difference in thickness between a central portion and a peripheral portion of the useful portion of the panel is suppressed to a level substantially equal to the conventional case, it is possible to prevent the generation of large thermal stress in the panel during a production process and to prevent the decrease in uniformity of image brightness. Furthermore, since the radius of curvature of an inner surface of the useful portion can be reduced, that of a perforated region of a shadow mask also can be reduced. This improves a curved surface retaining strength of the shadow mask, thereby reducing a local deformation of the shadow mask during the production process of a color picture tube. Additionally, even if a low-cost iron material is used as a material for the shadow mask, it still is possible to reduce the deterioration in color purity due to doming, so that an excellent color display can be achieved.

The following is a description of an embodiment of the present invention, with reference to the accompanying drawings.

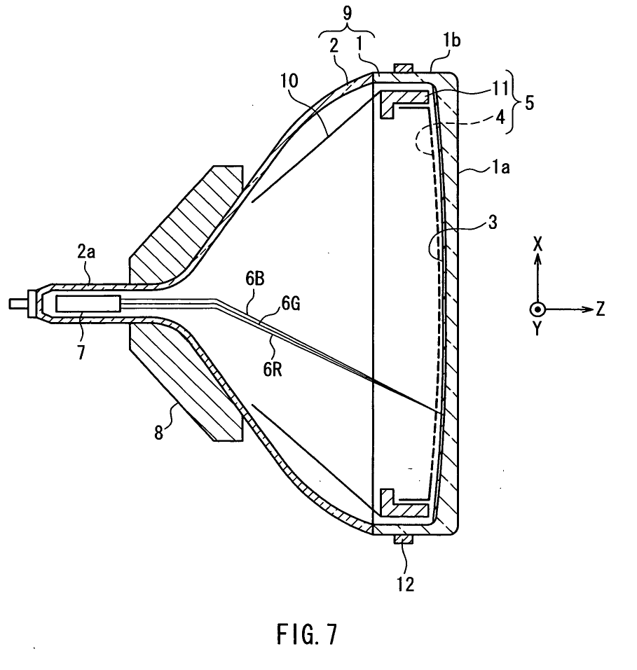

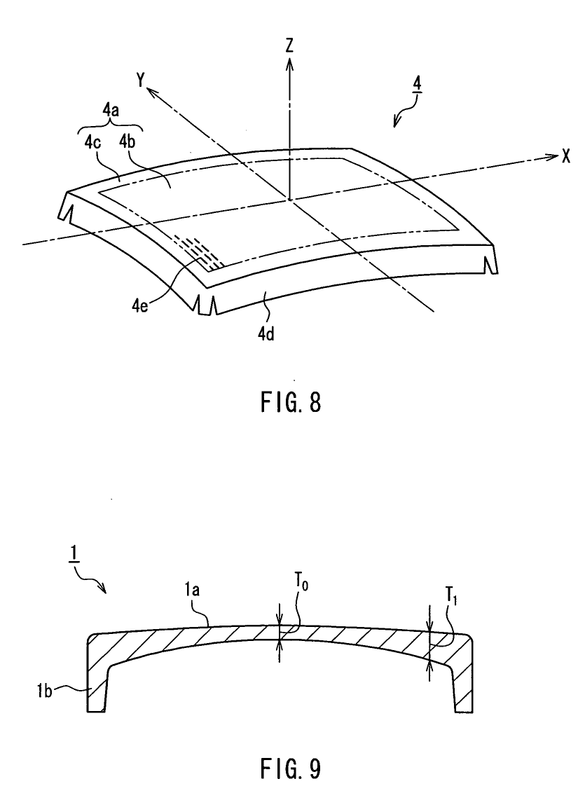

The schematic configuration of a color picture tube according to the present invention is not particularly limited except for the shape of inner and outer surfaces of a panel but may be the same as that of the conventional flat tube illustrated in FIG. 7, for example. Thus, in the following, the present invention will be described focusing mainly on the point different from the conventional flat tube.

The outer surface of a useful portion 1a of a panel 1 of the color picture tube according to the present invention is formed as a curved surface having a large radius of curvature that can be recognized as a substantially flat surface when viewed from a distance. The inner surface of the useful portion 1a is formed as a concavely curved surface having a predetermined radius of curvature. The inner surface of the panel 1 is provided with a substantially rectangular phosphor screen 3. In the present invention, a region on the inner surface of the panel 1 provided with the phosphor screen 3 and a region on the outer surface of the panel 1 corresponding thereto are referred to as the “useful portion 1a”.

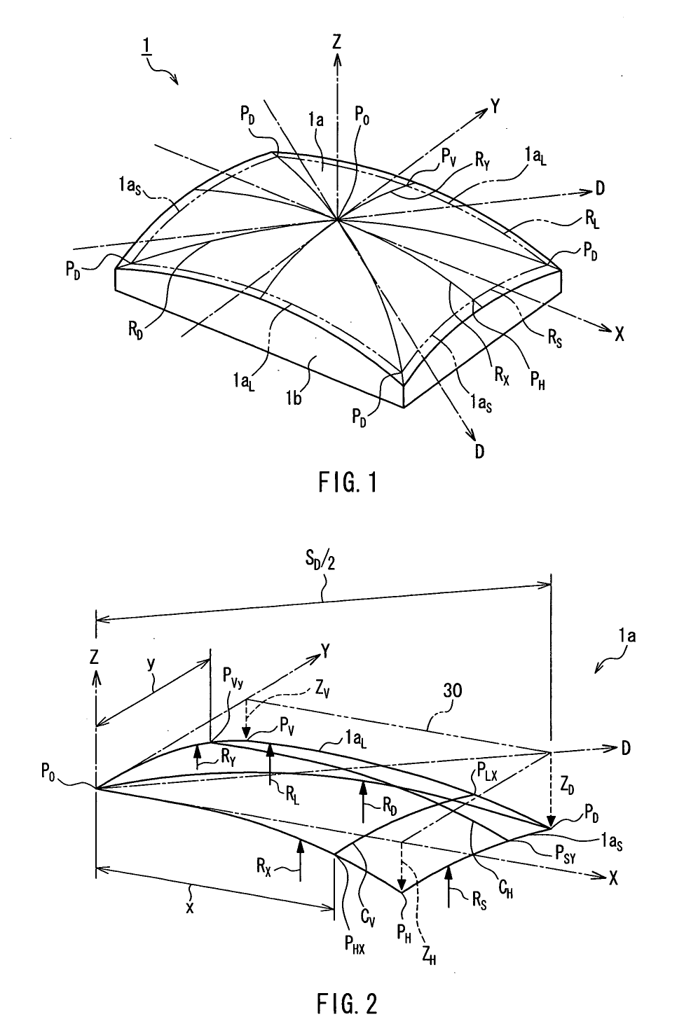

FIG. 1 is a perspective view showing a schematic shape of the panel 1 of the color picture tube according to an embodiment of the present invention. As shown in the figure, an axis that is perpendicular to a tangent plane 30 (see FIG. 2 described later) to the outer surface of the useful portion 1a at a center P₀ of the outer surface of the useful portion 1a of the panel 1 and passes through the center P₀ is a tube axis Z. Also, an axis that is parallel with long sides 1a_{L} of the useful portion 1a and orthogonal to the tube axis Z is a major axis X, and an axis that is parallel with short sides 1a_{S} of the useful portion 1a and orthogonal to the tube axis Z is a minor axis Y. Four points of intersection of a pair of the long sides 1a_{L} and a pair of the short sides 1a_{S} are diagonal axis ends P_{D}, and an axis that is parallel with a direction connecting two opposite diagonal axis ends P_{D} sandwiching the tube axis Z out of the four diagonal axis ends P_{D} and orthogonal to the tube axis Z is a diagonal axis D. Points of intersection of the short sides 1a_{S} of the useful portion 1a and a plane including the major axis X and the tube axis Z are major axis ends P_{H}, and points of intersection of the long sides 1a_{L} of the useful portion 1a and a plane including the minor axis Y and the tube axis Z are minor axis ends P_{V}.

FIG. 2 is a perspective view showing a shape of a first quadrant of the outer surface of the useful portion 1a divided by the major axis X and the minor axis Y Each shape of the outer and inner surfaces of the useful portion 1a is symmetrical with respect to an XZ plane (the plane including the major axis X and the tube axis Z) and a YZ plane (the plane including the minor axis Y and the tube axis Z).

As shown in FIG. 2, a radius of curvature R_{D} along the diagonal axis D of the outer surface of the useful portion 1a is defined by
R_{D}=[(S_{D}/2)²+Z_{D}²]/(2×Z_{D}), (1)
where S_{D} indicates a dimension of the useful portion 1a in the direction of the diagonal axis D and Z_{D} indicates a sagging amount along the direction of the tube axis Z at the diagonal axis end P_{D} with respect to the center P₀ on the outer surface of the useful portion 1a.

A radius of curvature R_{S} along the short side 1a_{S} of the outer surface of the useful portion 1a (namely, a radius of curvature in a cross-section at the short side 1a_{S} parallel with the minor axis Y and the tube axis Z) can be calculated similarly to the formula (1) above using the distance along the direction of the minor axis Y between the major axis end P_{H} and the diagonal axis end P_{D} and the difference in the sagging amount along the direction of the tube axis Z therebetween.

A radius of curvature R_{L} along the long side 1a_{L} of the outer surface of the useful portion 1a (namely, a radius of curvature in a cross-section at the long side 1a_{L} parallel with the major axis X and the tube axis Z) can be calculated similarly to the formula (1) above using the distance along the direction of the major axis X between the minor axis end P_{V} and the diagonal axis end P_{D} and the difference in the sagging amount along the direction of the tube axis Z therebetween.

The outer surface of the useful portion 1a of the panel 1 of the color picture tube according to the present invention is flattened such that its radius of curvature R_{D} along the diagonal axis D is at least 10 m.

Further, the radii of curvature R_{D}, R_{S} and R_{L} along the diagonal axis D, the short side 1a_{S} and the long side 1a_{L} of the outer surface of the useful portion 1a satisfy
R_{S}>R_{D}, and
R_{L}>R_{D}.

In the conventional flat tube, the outer surface of the useful portion 1a of the panel 1 has been a curved surface with a uniform radius of curvature (see “Conventional Example” described later). In other words, the radii of curvature R_{D}, R_{S} and R_{L} along the diagonal axis D, the short side 1a_{S} and the long side 1a_{L} of the outer surface of the useful portion 1a satisfy R_{D}=R_{S}=R_{L}. Compared with this conventional flat tube, the color picture tube according to the present invention has a relatively smaller radius of curvature R_{D} along the diagonal axis D. In the color picture tube of the present invention, according to this relatively small radius of curvature R_{D}, the radius of curvature of the inner surface of the useful portion 1a of the panel 1 along the diagonal axis D also is smaller than that of the conventional flat tube. Therefore, the color picture tube according to the present invention has substantially the same thickness of the useful portion 1a of the panel 1 as this conventional flat tube, thus preventing the decrease in uniformity of the image brightness and the problem of thermal stress during the production process.

When Z_{H} indicates a sagging amount along the direction of the tube axis Z at the major axis end P_{H}, Z_{V} indicates that at the minor axis end P_{V} and Z_{D} indicates that at the diagonal axis end P_{D} with respect to the center P₀ on the outer surface of the useful portion 1a,
Z_{V}+Z_{H}>Z_{D} (2)
is satisfied.

The formula (2) above is transformed into Z_{V}>(Z_{D}−Z_{H}) or Z_{H}>(Z_{D}−Z_{V}).

In other words, in a first color picture tube, the sagging amount Z_{V} along the direction of the tube axis Z at the minor axis end P_{V} with respect to the center P₀ of the useful portion 1a is larger than the sagging amount Z_{D}−Z_{H} along the direction of the tube axis Z at the diagonal axis end P_{D} with respect to the major axis end P_{H}.

Also, in a second color picture tube, the sagging amount Z_{H} along the direction of the tube axis Z at the major axis end P_{H} with respect to the center P₀ of the useful portion 1a is larger than the sagging amount Z_{D}−Z_{V} along the direction of the tube axis Z at the diagonal axis end P_{D} with respect to the minor axis end P_{V}.

A sagging amount Z along the direction of the tube axis Z at each point on the outer surface of the useful portion 1a with respect to the center P₀ can be approximated by
Z=A₁x²+A₂x⁴+A₃y²+A₄y⁴+A₅x²y²+A₆x⁴y²+A₇x²y⁴+A₈x⁴y⁴, (3)
where the center P₀ is a point of origin, using an x coordinate of the point in the direction of the major axis X and a y coordinate thereof in the direction of the minor axis Y. Here, A₁ to A₈ are constants.

The curve formed by the outer surface of the useful portion 1a in the cross-section including the minor axis Y and the tube axis Z can be approximated by
Z=A₃y²+A₄y⁴, (4)
as x=0 in the formula (3) above.

In the first color picture tube according to the present invention, it is preferable that a ratio of a biquadratic component of the formula (4) in the sagging amount Z_{V} at the minor axis end P_{V} is 10% to 40%. In other words, it is preferable to satisfy
10%≦[A₄y⁴/(A₃y²+A₄y⁴)]×100≦40%. (5)
This improves the visual flatness of the outer surface of the useful portion 1a, and makes it easier to ensure the compatibility of a front cabinet of a TV set with the conventional flat tube.

A curve C_{V} formed by the outer surface of the useful portion 1a in the cross-section that is at a distance x from the center P₀ in the direction of the major axis X and parallel with a plane including the minor axis Y and the tube axis Z can be expressed by an approximate formula combining a quadratic component and a biquadratic component, similarly to the formula (4). Now, Z_{V}x indicates a sagging amount along the direction of the tube axis Z at a point P_{L}X of intersection of the curve C_{V} and the long side 1a_{L} with respect to a point P_{H}X of intersection of the curve C_{V} and a plane including the major axis X and the tube axis Z. In the first color picture tube according to the present invention, it is preferable that the ratio of the biquadratic component in the sagging amount Z_{V}x decreases according to a quadric function with an increase in the distance x from the center P₀ of the useful portion 1a. This makes the shape of the outer surface of the useful portion 1a along the short side 1a_{S} equivalent to that of the conventional flat tube, so that the compatibility of the front cabinet of the TV set with this conventional flat tube can be ensured more easily.

In this case, it is preferable that the biquadratic component disappears on the short side 1a_{S} of the useful portion 1a. In other words, it is preferable that a curve representing a shape of the outer surface of the useful portion 1a along the short side 1a_{S} of the useful portion 1a is a circular arc or a quadric curve. This makes it even easier to ensure the compatibility of the front cabinet of the TV set with this conventional flat tube.

Similarly, the curve formed by the outer surface of the useful portion 1a in the cross-section including the major axis X and the tube axis Z can be approximated by
Z=A₁x²+A₂x⁴, (6)
as y=0 in the formula (3) above.

In the second color picture tube according to the present invention, it is preferable that a ratio of a biquadratic component of the formula (6) in the sagging amount Z_{H} at the major axis end P_{H} is 10% to 40%. In other words, it is preferable to satisfy
10%≦[A₂x⁴/(A₁x²+A₂x⁴)]×100≦40%. (7)
This improves the visual flatness of the outer surface of the useful portion 1a, and makes it easier to ensure the compatibility of a front cabinet of a TV set with the conventional flat tube.

A curve C_{H} formed by the outer surface of the useful portion 1a in the cross-section that is at a distance y from the center P₀ in the direction of the minor axis Y and parallel with a plane including the major axis X and the tube axis Z can be expressed by an approximate formula combining a quadratic component and a biquadratic component, similarly to the formula (6). Now, Z_{H}Y indicates a sagging amount along the direction of the tube axis Z at a point P_{S}y of intersection of the curve C_{H} and the short side 1a_{S} with respect to a point P_{V}y of intersection of the curve C_{H} and a plane including the minor axis Y and the tube axis Z. In the second color picture tube according to the present invention, it is preferable that the ratio of the biquadratic component in the sagging amount Z_{H}y decreases according to a quadric function with an increase in the distance y from the center P₀ of the useful portion 1a. This makes the shape of the outer surface of the useful portion 1a along the long side 1a_{L} equivalent to that of the conventional flat tube, so that the compatibility of the front cabinet of the TV set with this conventional flat tube can be ensured more easily.

In this case, it is preferable that the biquadratic component disappears on the long side 1a_{L} of the useful portion 1a. In other words, it is preferable that a curve representing the shape of the outer surface of the useful portion 1a along the long side 1a_{L} of the useful portion 1a is a circular arc or a quadric curve. This makes it even easier to ensure the compatibility of the front cabinet of the TV set with this conventional flat tube.

It is preferable that the radius of curvature R_{S} of the outer surface of the useful portion 1a along the short side 1a_{S} and the radius of curvature R_{L} thereof along the long side 1a_{L} are substantially the same. This provides a natural visibility for the screen. When the radius of curvature R_{S} and the radius of curvature R_{L} differ considerably, the curvature in one direction is noticeable, so that the screen is recognized as being cylindrical, resulting in deterioration in the visual flatness. Also, it is possible to reduce an incongruity with the conventional flat tube, which often has the panel 1 whose useful portion 1a has a curved outer surface with a uniform radius of curvature as described above. More specifically, when 0.93<R_{S}/R_{L}<1.07 is satisfied, the radius of curvature R_{S} and the radius of curvature R_{L} can be considered substantially equal. Further, it is preferable to satisfy 0.97≦R_{S}/R_{L}≦1.03 and, particularly, R_{S}=R_{L}.

It also is preferable to satisfy R_{D}<R_{S}/2 and R_{D}<R_{L}/2. This makes it possible to reduce the radius of curvature of the inner surface of the useful portion 1a of the panel 1 along the diagonal axis D further, so that the difference in thickness between the central portion and the peripheral portion of the useful portion 1a of the panel 1 can be reduced further.

It also is preferable to satisfy R_{S}>50 m and R_{L}>50 m. This makes it possible to achieve an excellent flatness of the outer surface of the useful portion 1a of the panel 1. Moreover, the front cabinet of the TV set in which the conventional flat tube has been incorporated can be applied to the color picture tube according to the present invention without making any design modifications.

It is preferable that the shadow mask 4 of the color picture tube according to the present invention is formed of a material containing at least 95% of iron. This can reduce the cost of the shadow mask 4. This also achieves an excellent formability of the shadow mask 4.

Further, it is preferable that a transmittance of the useful portion 1a of the panel 1 at the center P₀ is equal to or lower than 60%. In other words, it is preferable that the panel 1 is formed of a so-called tinted glass material whose visible light transmittance is small. This reduces the reflection of external light on the inner surface of the panel 1, thus improving the contrast of the image. In the color picture tube according to the present invention, since the difference in thickness between the central portion and the peripheral portion of the useful portion 1a of the panel 1 is substantially equivalent to that in the conventional flat tube, the use of the tinted glass material does not lower the uniformity of image brightness.

### EXAMPLE

The following is a description of an example of applying the present invention to a 68-cm-diagonal color picture tube with an aspect ratio of 4:3 (hereinafter, referred to as “Example”).

A useful portion 1a of a panel 1 of the color picture tube according to the present Example had a thickness T₀ at its center P₀ of 11.5 mm and a transmittance at the center P₀ of 54%. As a material for a shadow mask 4, aluminum killed decarbonized steel made of high-purity iron having a coefficient of thermal expansion of 12×10⁻⁶ at 0° C. to 100° C. was used.

For comparison, the conventional flat tube having a panel 1 whose useful portion 1a had a curved outer surface with a uniform radius of curvature was produced (hereinafter, referred to as “Conventional Example”).

On the outer surface of the useful portion 1a of the panel 1, a radius of curvature along its diagonal axis D was indicated by R_{D}, a radius of curvature along its long side 1a_{L} was indicated by R_{L}, a radius of curvature along its short side 1a_{S} was indicated by R_{S}, a radius of curvature along its major axis X (namely, a radius of curvature in a cross-section including the major axis X and a tube axis Z) was indicated by Rx, and a radius of curvature along its minor axis Y (namely, a radius of curvature in a cross-section including the minor axis Y and the tube axis Z) was indicated by R_{Y}. Table 1 shows the individual radii of curvature in Example and Conventional Example.

TABLE 1

| Outer surface | Example | Conventional Example |
|---|---|---|
| R_{D} | 20071 | 50000 |
| R_{L} | 50674 | 50000 |
| R_{S} | 52020 | 50000 |
| R_{X} | 14917 | 50000 |
| R_{Y} | 9679 | 50000 |

unit: mm

The present Example achieved R_{S}/R_{L}=1.03.

In Example and Conventional Example, sagging amounts Z_{H}, Z_{V} and Z_{D} along a direction of the tube axis Z at a major axis end P_{H}, a minor axis end P_{V} and a diagonal axis end P_{D} with respect to the center P₀ on the outer surface of the useful portion 1a were as shown in Table 2. In Table 2, Z_{D}−Z_{V} is a sagging amount along the direction of the tube axis Z at the diagonal axis end P_{D} with respect to the minor axis end P_{V}, and Z_{D}−Z_{H} is a sagging amount along the direction of the tube axis Z at the diagonal axis end P_{D} with respect to the major axis end P_{H}.

TABLE 2

| Outer surface | Example | Conventional Example |
|---|---|---|
| Z_{D} | 2.88 | 1.16 |
| Z_{D} − Z_{V} | 0.73 | 0.74 |
| Z_{D} − Z_{H} | 0.40 | 0.42 |
| Z_{H} | 2.48 | 0.74 |
| Z_{V} | 2.15 | 0.42 |

unit: mm

The panel according to Example satisfied Z_{V}>(Z_{D}−Z_{H}) and Z_{H}>(Z_{D}−Z_{V}).

Further, on an inner surface of the useful portion 1a of the panel 1, a radius of curvature along its diagonal axis D was indicated by R_{Di}, a radius of curvature along its long side 1a_{L} was indicated by R_{Li}, a radius of curvature along its short side 1a_{S} was indicated by R_{Si}, a radius of curvature along its major axis X (namely, a radius of curvature in the cross-section including the major axis X and the tube axis Z) was indicated by R_{Xi}, and a radius of curvature along its minor axis Y (namely, a radius of curvature in the cross-section including the minor axis Y and the tube axis Z) was indicated by R_{Yi}. Table 3 shows the individual radii of curvature in Example and Conventional Example.

TABLE 3

| Inner surface | Example | Conventional Example |
|---|---|---|
| R_{Di} | 2840 | 3150 |
| R_{Li} | 7170 | 7310 |
| R_{Si} | 1830 | 1830 |
| R_{Xi} | 4110 | 5290 |
| R_{Yi} | 1370 | 1570 |

unit: mm

In Example and Conventional Example, sagging amounts Z_{Hi}, Z_{Vi} and Z_{Di} along the direction of the tube axis Z at the major axis end P_{H}, the minor axis end P_{V} and the diagonal axis end P_{D} with respect to the center P₀ on the inner surface of the useful portion 1a were as shown in Table 4. In Table 4, Z_{Di}−Z_{Vi} is a sagging amount along the direction of the tube axis Z at the diagonal axis end P_{D} with respect to the minor axis end P_{V}, and Z_{Di}−Z_{Hi} is a sagging amount along the direction of the tube axis Z at the diagonal axis end P_{D} with respect to the major axis end P_{H}.

TABLE 4

| Inner surface | Example | Conventional Example |
|---|---|---|
| Z_{Di} | 20.43 | 18.40 |
| Z_{Di} − Z_{Vi} | 5.15 | 5.09 |
| Z_{Di} − Z_{Hi} | 11.42 | 11.41 |
| Z_{Hi} | 9.01 | 7.00 |
| Z_{Vi} | 15.27 | 13.31 |

unit: mm

With the sagging amounts of the outer surface at the center P₀, the minor axis end P_{V} and a midpoint between these two points, it was possible to approximate a curve formed by the outer surface of the useful portion 1a in the cross-section including the minor axis Y and the tube axis Z of the panel according to Example by
Z=4.16×10⁻⁵·y²+2.42×10⁻¹⁰·y⁴.
The distance along the direction of the minor axis X from the center P₀ to the minor axis end P_{V} was 204 mm, and the ratio of a biquadratic component in the sagging amount Z_{V} at the minor axis end P_{V} was
2.42×10⁻¹⁰·y⁴/(4.16×10⁻⁵·y²+2.42×10⁻¹⁰·y⁴)×100=19%.

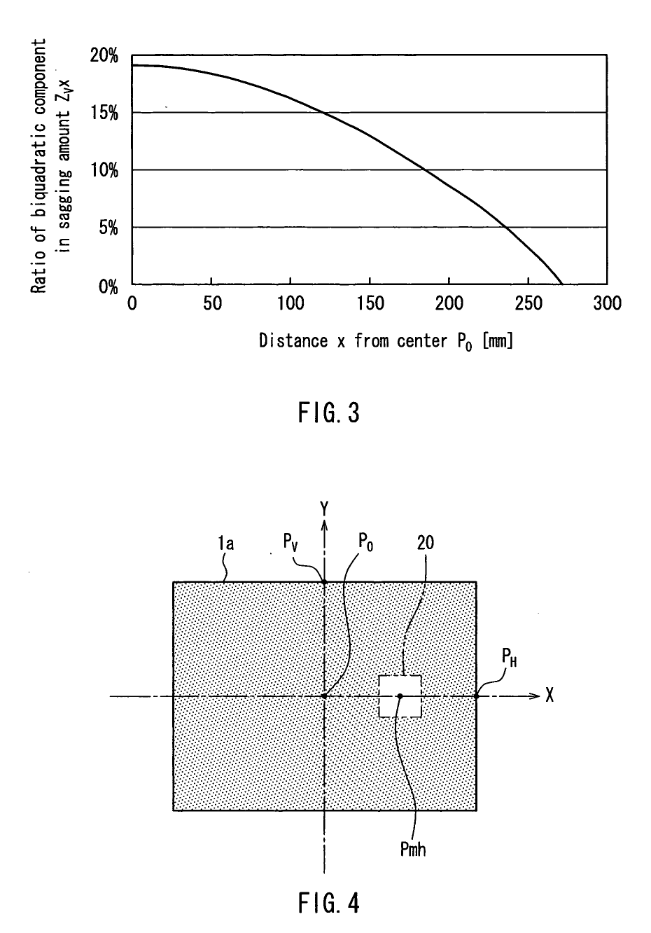

In the panel according to Example, it was possible to express a curve C_{V} formed by the outer surface of the useful portion 1a in a cross-section that was at a distance x from the center P₀ in the direction of the major axis X and parallel with a plane including the minor axis Y and the tube axis Z by an approximate formula combining a quadratic component and a biquadratic component. When a sagging amount along the direction of the tube axis Z at a point P_{L}X of intersection of the curve C_{V} and the long side 1a_{L} with respect to a point P_{H}X of intersection of the curve C_{V} and a plane including the major axis X and the tube axis Z was indicated by Z_{V}x, the ratio of the biquadratic component in the sagging amount Z_{V}x decreased according to a quadric function as shown in FIG. 3 with an increase in the distance x from the center P₀ of the useful portion 1a and reached 0 on the short side (x=272 mm).

With the sagging amounts of the outer surface at the center P₀, the major axis end P_{H} and a midpoint between these two points, it was possible to approximate a curve formed by the outer surface of the useful portion 1a in the cross-section including the major axis X and the tube axis Z of the panel according to Example by
Z=2.69×10⁻⁵·x²+8.89×10⁻¹·x⁴.
The distance along the direction of the major axis X from the center P₀ to the major axis end P_{H} was 272 mm, and the ratio of a biquadratic component in the sagging amount Z_{H} at the major axis end P_{H} was
8.89×10⁻¹¹·x⁴/(2.69×10⁻⁵·x²+8.89×10⁻¹¹·x⁴)×100=20%.

In the panel according to Example, it was possible to express a curve C_{H} formed by the outer surface of the useful portion 1a in a cross-section that was at a distance y from the center P₀ in the direction of the minor axis Y and parallel with a plane including the major axis X and the tube axis Z by an approximate formula combining a quadratic component and a biquadratic component. When a sagging amount along the direction of the tube axis Z at a point P_{S}y of intersection of the curve C_{H} and the short side 1a_{S} with respect to a point P_{V}y of intersection of the curve C_{H} and a plane including the minor axis Y and the tube axis Z was indicated by Z_{H}y, the ratio of the biquadratic component in the sagging amount Z_{H}y decreased according to a quadric function with an increase in the distance y from the center P₀ of the useful portion 1a and reached 0 on the long side (y=204 mm).

According to the fact that the outer surface of the useful portion 1a of the panel 1 in Example had a smaller radius of curvature R_{D} along the diagonal axis D than that in Conventional Example, the inner surface of the useful portion 1a in Example also had a smaller radius of curvature R_{Di} along the diagonal axis D than that in Conventional Example. Therefore, in Example, the radius of curvature of a perforated region 4b of the shadow mask 4 was set to be smaller than that in Conventional Example so as to conform to the shape of the inner surface of this useful portion 1a.

In the color picture tubes according to Example and Conventional Example, in the case of displaying white only in a square region 20 whose center was located at a point Pmh with x=185 mm on the X axis and displaying black in the other regions as shown in FIG. 4, a movement amount of electron beams (“a beam movement amount”) due to doming at the point Pmh was measured. Table 5 shows the results. A smaller beam movement amount resulted in less deterioration in the image caused by the deterioration in color purity.

TABLE 5

| | Example | Conventional Example |
|---|---|---|
| Beam movement amount | 300 | 330 |

unit: μm

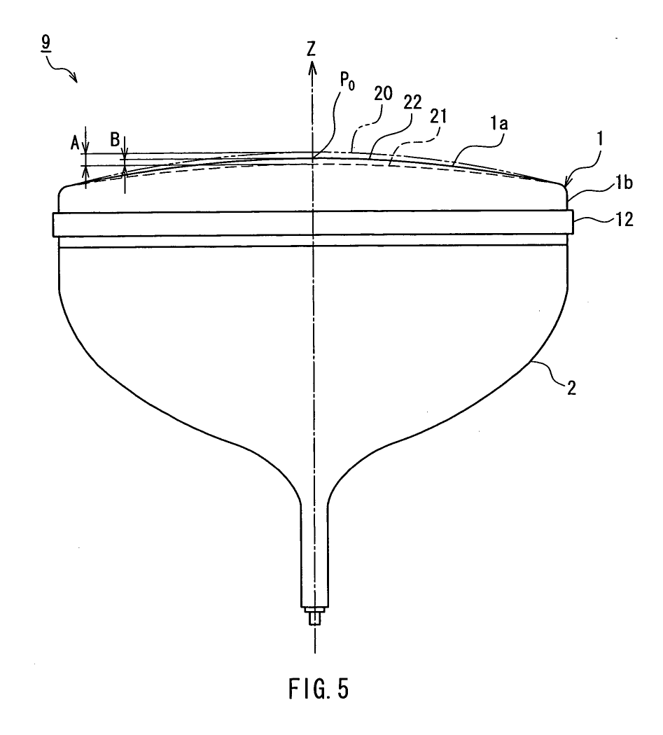

In order to evaluate implosion-protection characteristics of an envelope 9, a sagging back ratio by a reinforcing band 12 was measured. The measurement was made in the following manner. As shown in FIG. 5, the outer surface of the useful portion 1a of the panel 1 changed its shape from a chain double-dashed line 20 to a broken line 21 by producing a vacuum in an inner space of the envelope 9. A displacement amount A in the direction of the tube axis Z at the center P₀ of the useful portion 1a caused by this change was measured. Next, the reinforcing band 12 was mounted on a lateral wall portion 1b of the panel 1. By mounting the reinforcing band 12, the outer surface of the useful portion 1a of the panel 1 changed its shape from the broken line 21 to a solid line 22. A displacement amount B in the direction of the tube axis Z at the center P₀ of the useful portion 1a caused by this change was measured. In other words, when a vacuum was produced in the inner space of the envelope 9, the outer surface of the useful portion 1a of the panel 1 was deformed inwardly in such a manner as to be pressed into the envelope 9 by the displacement amount A. Thereafter, when the reinforcing band 12 was mounted, this inwardly deformed amount A was recovered partially (a recovery amount B). A sagging back ratio SB was a ratio of recovering the inward deformation when the reinforcing band 12 was mounted, and calculated by
SB=(B/A)×100(%).

Table 6 shows the results of measuring the sagging back ratios in Example and Conventional Example. It is noted that the same reinforcing band 12 was used in both Example and Conventional Example.

TABLE 6

| | Example | Conventional Example |
|---|---|---|
| Sagging back ratio | 26.9 | 22.9 |

unit: %

Since the outer surface of the useful portion 1a of the panel 1 in Example had a smaller radius of curvature R_{D} along the diagonal axis D than that in Conventional Example, the sagging back ratio of Example was larger despite the fact that the reinforcing band 12 having the same embracing force was mounted. A large sagging back ratio indicates improved implosion-protection characteristics of the color picture tube. Thus, if implosion-protection characteristics equivalent to those in Conventional Example were sufficient, it was possible to make the embracing force of the reinforcing band 12 in Example smaller than that in Conventional Example. More specifically, in Example, it was possible to make the thickness or width of the reinforcing band 12 smaller than that in Conventional Example, thereby achieving the cost reduction of the reinforcing band 12. Alternatively, in the case of using the same reinforcing band 12 as that in Conventional Example, it was possible to reduce the thickness of the central portion of the useful portion 1a of the panel 1 in Example, thereby reducing a glass material to achieve the cost reduction of the panel 1.

With regard to the visibility of the screen, in general, a portion in which the flatness of the screen is perceived most keenly is a peripheral portion of the rectangular screen, namely, long sides and short sides thereof. A screen frame of the front cabinet of the TV set into which the color picture tube is incorporated has a rectangular shape, in other words, linear long sides and linear short sides when viewed from the front. Therefore, if a peripheral portion of the outer surface of the useful portion 1a of the panel 1 is curved, the roundness of the screen is very noticeable, thus lowering the visibility.

In Example, although the outer surface of the useful portion 1a of the panel 1 had a smaller radius of curvature R_{D} along the diagonal axis D than that in Conventional Example, it had radii of curvature R_{S} and R_{L} along the short side 1a_{S} and the long side 1a_{L}, where the curve tended to be noticeable, substantially equal to those in Conventional Example. Thus, considering the flatness of the outer surface of the useful portion 1a of the panel 1, despite the fact that the outer surface of the useful portion 1a in Example had a small radius of curvature R_{D} along the diagonal axis D, substantially no difference from Conventional Example was perceived. Also, when the color picture tube according to Example was incorporated into the conventional TV set into which the color picture tube according to Conventional Example was to be incorporated, there was no gap between the outer surface of the panel 1 and the screen frame of the front cabinet. Consequently, it was confirmed that the front cabinet of the conventional TV set was applicable to the color picture tube according to Example without making any design modifications.

The following is the result of evaluating a reflected image of external light around the color picture tube on the outer surface of the useful portion 1a of the panel 1. The evaluation was made in the following manner. A point of view was set on a normal line of a tangent plane 30 to the outer surface of the useful portion 1a at the center P₀, and a subject prepared by drawing a grid pattern on a flat surface was placed perpendicularly to this normal line on the side opposite to the useful portion 1a with respect to the point of view. Then, a subject image that was reflected on the outer surface of the useful portion 1a and recognized at the point of view was determined analytically.

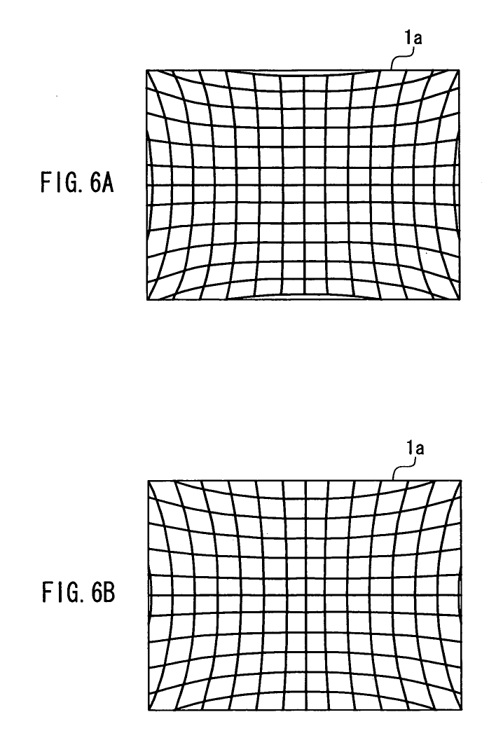

FIG. 6A shows the analysis result for the panel according to Example. FIG. 6B shows the analysis result for a panel that is the same as the panel according to Example except that its useful portion 1a had an outer surface satisfying R_{D}=R_{L}=R_{S}=R_{X}=R_{Y}=20071 mm (hereinafter, referred to as “Comparative Example”).

In the conventional flat tube, the useful portion 1a has had an outer surface satisfying R_{D}=R_{L}=R_{S}=R_{X}=R_{Y}=50000 mm, for example, as illustrated by Conventional Example described above. Such a conventional flat tube has had problems in that the color purity is deteriorated due to doming and the embracing force of the reinforcing band has to be increased. In order to solve these problems, Comparative Example was produced by reducing the radius of curvature of the outer surface of the useful portion 1a down to a value equal to R_{D} of Example while maintaining the characteristic of the conventional flat tube in which the useful portion 1a has a curved outer surface with a uniform radius of curvature.

As shown in FIG. 6B, even when the radius of curvature of the outer surface of the useful portion 1a of the conventional flat tube simply was reduced, a subject image still had a large distortion especially in the peripheral portion of the outer surface of the useful portion 1a (namely, the vicinities of the long sides and the short sides of the screen). Accordingly, it was not possible to achieve a visual flatness of the outer surface of the useful portion 1a.

On the other hand, in Example, the curved shape of the outer surface of the useful portion 1a of the panel 1 contained an aspherical component. Therefore, although the reflected image of external light had some distortion, an overall incongruity of the subject image was minimized. This was because, in Example, 1) the curved shape of the surface along the minor axis Y and the major axis X can be expressed by the approximate formula combining the quadratic component and the biquadratic component, with the ratio of the biquadratic component in the sagging amount Z_{V} at the minor axis end P_{V} being 10% to 40% and the ratio of the biquadratic component in the sagging amount Z_{H} at the major axis end P_{H} being 10% to 40%, and 2) the ratio of the biquadratic component in the sagging amount Z_{V}x decreased according to a quadric function with an increase in the distance x from the center P₀ to the curve C_{V} of the useful portion 1a and the ratio of the biquadratic component in the sagging amount Z_{H}y decreased according to a quadric function with an increase in the distance y from the center P₀ to the curve C_{H} of the useful portion 1a.

Since the present invention achieves an excellent uniformity of image brightness and has reduced deterioration in color purity due to doming, while providing a visual flatness of the outer surface of the panel, it is possible to achieve an excellent color display in an inexpensive manner, without any particular limitation on its field of application. For example, the present invention can be utilized widely as a color picture tube for a television receiver or a computer display.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A color picture tube comprising:
a panel having a substantially rectangular useful portion whose inner surface is provided with a phosphor screen; and
a shadow mask having a perforated region as a curved surface provided with a large number of apertures for passing electron beams;
wherein, assuming that an axis that is perpendicular to a tangent plane to an outer surface of the useful portion at a center of the useful portion and passes through the center is a tube axis and a point of intersection of a short side and a long side of the useful portion is a diagonal axis end,
the color picture tube satisfies
R_{D}≧10 m,
R_{S}>R_{D}, and
R_{L}>R_{D},
where R_{D}, defined by
R_{D}=[(S_{D}/2)²+Z_{D}²]/(2×Z_{D}) (1)
using a dimension S_{D} of the useful portion in a direction of the diagonal axis and a sagging amount Z_{D} along a direction of the tube axis at the diagonal axis end with respect to the center on the outer surface of the useful portion, indicates a radius of curvature along the diagonal axis of the outer surface of the useful portion, R_{S} indicates a radius of curvature along the short side of the outer surface of the useful portion, and R_{L} indicates a radius of curvature along the long side of the outer surface of the useful portion.

2. The color picture tube according to claim 1, wherein, assuming that an axis that is parallel with the short side of the useful portion and orthogonal to the tube axis is a minor axis, a point of intersection of the long side of the useful portion and a plane including the minor axis and the tube axis is a minor axis end and Z_{V} indicates a sagging amount along the direction of the tube axis at the minor axis end with respect to the center on the outer surface of the useful portion, a ratio of a biquadratic component in the sagging amount Z_{V} at the minor axis end is 10% to 40% when a curve formed by the outer surface of the useful portion in a cross-section including the minor axis and the tube axis is expressed by an approximate formula combining a quadratic component and the biquadratic component.

3. The color picture tube according to claim 1, wherein, assuming that an axis that is parallel with the long side of the useful portion and orthogonal to the tube axis is a major axis, a point of intersection of the short side of the useful portion and a plane including the major axis and the tube axis is a major axis end and Z_{H} indicates a sagging amount along the direction of the tube axis at the major axis end with respect to the center on the outer surface of the useful portion, a ratio of a biquadratic component in the sagging amount Z_{H} at the major axis end is 10% to 40% when a curve formed by the outer surface of the useful portion in a cross-section including the major axis and the tube axis is expressed by an approximate formula combining a quadratic component and the biquadratic component.

4. The color picture tube according to claim 1, wherein a curve representing a shape of the outer surface of the useful portion along the short side of the useful portion is a circular arc or a quadric curve.

5. The color picture tube according to claim 1, wherein a curve representing a shape of the outer surface of the useful portion along the long side of the useful portion is a circular arc or a quadric curve.

6. The color picture tube according to claim 1, which satisfies 0.93<R_{S}/R_{L}<1.07.

7. The color picture tube according to claim 1, which satisfies R_{D}<R_{S}/2 and R_{D}<R_{L}/2.

8. The color picture tube according to claim 1, which satisfies R_{S}>50 m and R_{L}>50 m.

9. The color picture tube according to claim 1, wherein the shadow mask is formed of a material containing at least 95% of iron.

10. The color picture tube according to claim 1, wherein a transmittance of the useful portion of the panel at the center is equal to or lower than 60%.
